(19) United States
(12) Patent Application Publication
(10) Pub. No.: US 2021/0037834 A1
(43) Pub. Date: Feb. 11, 2021

(54) METHOD OF PREPARING PRODUCTS MADE OF DOUGH HAVING A FILLING OF BYPRODUCTS

(71) Applicant: Krasilnikov Andrey Vasilievich, Orenburg region, Orsk (RU)

(72) Inventor: Krasilnikov Andrey Vasilievich, Orenburg region, Orsk (RU)

(21) Appl. No.: 16/615,662

(22) PCT Filed: Oct. 18, 2018
(86) PCT No.: PCT/RU2018/000694

§ 371 Date: Nov. 21, 2019

(30) Foreign Application Priority Data
Mar. 6, 2018 (RU) 2018108146

(51) Int. Cl. A21D 13/38; A23L 13/60; A21D 8/04; A21D 13/31; A23L 13/20

(52) U.S. Cl. CPC A21D 13/38; A23L 13/67; A21D 8/047; A23V 2002/00; A23L 13/62; A23L 13/20; A21D 13/31

(57) ABSTRACT

Kneading the yeast fermented dough in the sourdough way: the flour is poured into warm water, in which sugar, salt, yeast are diluted, the dough is matured for 20 minutes, the dough is received semi-fluid, the dough is cut on the surface with greased vegetable oil; the stuffing is prepared from offal of farm animals or poultry, with the addition in stuffing ingredients onions in an amount of 10-20% of weight of the stuffing, salts, pepper to taste and further cooking steps are carried out. The method allows to prepare products with the optimal technological characteristics having high nutritional value and organoleptic properties of softness, juiciness, creamy taste.

### THE TECHNICAL FIELD TO WHICH THE INVENTION BELONGS

The invention retails to the food industry, in the field of satisfaction of vital needs of the person in the conditions of public catering, can be used in public points of fast food. The method relates to technology of preparation of dough products with a stuffing from an offal, cooking before consumption by frying in deep fat. The method includes the preparation of the dough, the preparation of the stuffing, the formation of the product, the frying of the formed products in deep fat, the use of fat components for deep frying with addition of citric acid and the possibility of freezing of the product and its storage in a sealed package.

### LEVEL OF THE INVENTION

Numerous methods for preparing dough products with a stuffing made by frying are known.

The method for production of fried pies with a fish stuffing is known, providing preparation of yeast dough and fish forcemeat, cutting of the dough, forming pies with a forcemeat stuffing, proofing dough and frying, for preparation of fish forcemeat the prescription components are prepared, the pike perch is cut, blanched with steam and cut, fresh white cabbage is chopped and frozen, eggs are cooked by hard-boiled, cleaned and crushed, onions are sautéed in butter to brown, and then mix the listed components without oxygen access with bitter black pepper and salt (patent RU 2280365 C2, May 12, 2004). The imperfection of the existing method is the complexity, multi-stage and duration of the technological process of production with fish stuffing.

The method for the production of fried pies with a fish stuffing is known, which provides for the preparation of prescription components, blanching and cutting of pike-perch fillet, cooking, cleaning and cutting of eggs, cutting and sautéing onions in butter, shredding and freezing fresh cabbage, mixing the listed components with salt and bitter pepper black bitter with receiving a stuffing using ornamental cabbage, preparing yeast dough, cutting it, forming the stuffing into dough, proofing pastry and baking. (patent RU 2578343 C1 patent, Jan. 20, 2015).

The imperfection of the existing method is the complexity, multi-gradualness and duration of the manufacturing process of production with fish stuffing.

The method for the production of dough products with a stuffing is known, including preparation of the dough, preparation of the stuffing, which before the formation of the product is dehydrated by 20-60% and after molding the product is dried by microwave radiation in a temperature interval of 20-120° C. to a humidity of 6-12%, molding of the product, storage in a package with subsequent heat treatment before the use (patent RU 2251271 C1, Oct. 6, 2003).

The imperfection of the existing method are not sufficiently high tastes qualities of the resulting products in view of the loss of beneficial nutritional properties of the stuffing because of the stage of dehydration for 20%-60% and subsequent drying to a humidity content of 6-12%.

The most closest in essence to the claimed invention, the prototype, is the method for preparing dough products with a stuffing like «Cheburek» type, including kneading the dough by introduction wheat flour into salt water or milk, keeping pastry within 15-30 minutes, handling pastry into separate flat cakes, laying the stuffing on them, molding the products and frying them in deep-frying, as part of the stuffing, use crumbled cheese of hard varieties with a fat content of 40-45%, into which the crumbled greens of parsley and okama» (anethum graveolens) in an amount of 5-10% by weight of the stuffing, in the dough at the kneading stage in addition is supplemented monosaccharides in an amount of 15% of the mass of the pastry. (patent RU 2093988 C1, Mar. 17, 1997).

The imperfection of the prototype is the insufficiently high useful nutritional properties of products due to the presence of monosaccharides in an amount of 15% of the mass of the pastry, which reduces the dietary properties of products and increases the caloric content of finished products, and the use of a mixture of polysaccharides in such an amount gives the finished product a rubber-like structure in the paste cover, which leads to a deterioration in the quality of finished products and the loss the commodity shape of finished products.

The present invention relates to a method for preparing products from yeast dough with with stuffed by offal.

### ESSENCE OF THE INVENTION

The purpose of the prospective invention is to develop a recipe of a functional product having a high nutritional value, physico-chemical and biological, organoleptic characteristics, allowing to prepare the product with optimal technological characteristics: production time, simplicity of technological operations, accessibility of the raw materials used, affordability.

The purpose of the proposed invention is to increase the biological value of the ready-made product and its preservation in the course of culinary processing of the finished product, carried out by frying in deep fat.

The purpose of the proposed invention is to ensure the profitability and rapid efficiency of the production of dough products with stuffing taking into account minimization of the sizes of products.

The technical result, to achieve which the claimed invention is directed consists is to increase the functional and nutritional value of the finished products and at the same time decrease the caloric content of the resulting products.

The aim is achieved by the fact that the method of preparing dough products with stuffing, includes kneading yeast dough, produce a precipitation of wheat flour of the highest grade into warm water, in which sugar, salt, yeast are diluted, the dough is kept to mature dough for 20 minutes, the dough turns semi-fluid, the dough is handled into small workpieces weighing from 10 to 40 grams, roll the workpieces on the surface, greased with vegetable oil in the form of small flat cakes. Prepare the stuffing, consisting:

from offal of farm animals (beef, pork, mutton) liver, lung, heart, kidneys; or from offal of poultry (chicken, goose): stomachs, a liver, heart, with the addition of fresh onions,

describable in its composition by a sufficient number of biologically valuable components and lower caloric content which is characterized in comparison with meat stuffing.

At the same time, the technological process of preparing the stuffing includes the condition that the offal is boiled in water for 2 hours, some spice are added to water, in the proportion one liter of water: black pepper peas 5 grams, crumbled onions 40 grams, garlic 5 grams, then the boiled components of the stuffing are passed through a meat grinder, the received minced meat is slightly stewed in vegetable oil for 10 to 20 minutes, at the end of suppression add fresh onions, which are passed through a meat grinder in the ratio of 10% of −20% of the mass of the stuffing. The mixture of minced meat is added pepper, salt to taste.

At formation products are given a certain shape of the ball with a diameter of 3 to 6 cm, which provides simplicity of manufacture, and also cost-effectiveness and rapid production efficiency in dough products with the stuffing.

Also, the specified technical result is achieved by the fact that the received finished products in the form of balls are deep fried at a temperature 170-190° C. At the same time, in the fat components for deep-frying, consisting of animal fat of the highest grade (pork fat, beef fat, lamb fat) add vegetable oils in the ratio by weight., %: 40% vegetable oil.

In order to prevent oxidative processes in the fat mixture during deep frying, citric acid is added at the rate of 2-3 grams per 100-150 grams of fat, which contributes to the beating of the smell when using animal fat without losing the taste of products that distinguish organoleptic characteristics, such as softness, juiciness.

When the composition of fat components for deep-frying from a mixture of vegetable oils and melted butter in a ratio of 3:1, a feature of the finished products, fried in such a mixture, is a change in organoleptic characteristics, the finished products are complemented by a pleasant, creamy taste according to 1 point of invention formula.

Deep frying foods has a significant effect on fats. Frying products occurs at high temperatures and is accompanied by the combustion of small particles of products that have a catalytic effect on the process of decomposition of fats. For frying in oil is dominated by oxidative processes. First of all, fats are oxidized, which include unsaturated fatty acids having double bonds in the molecule. First, peroxides and hydroperoxides (primary oxidation products) are formed at the site of the rupture of double bonds. These compounds are highly reactive and soon break down to form intermediate (alcohols, aldehydes, ketones, and apocii) and then secondary (dicarbonyl derivatives, di- and polyoxidonium acids, derivatives of acids with two conjugated double bonds, etc.) of oxidation products. Accumulated oxidation products are prone to polymerization and polycondensation reactions, as evidenced by an increase in fat viscosity. In this case, the color of the fried products becomes brown.

In addition to oxidizing processes, in fats during deep-frying partially hydrolytic processes are due to moisture of the fried products. Physical and chemical changes occurring in fat during frying, lead to changes in its color, taste and smell. One of the reasons for the appearance of dark color and deterioration of taste of products is the reaction of melanoidin formation. The source of amine groups for this process can be fried foods and phosphatides of unrefined oils.

To prevent oxidative processes of fat changes in the frying process, citric acid is added to the frying at the rate of 2-3 grams per 100-150 grams of fat, and the temperature regime is observed, the frying of finished products should be at a temperature of 170-190° C., heating of fats over 190° C. is unacceptable, since as a result of strong decomposition (pyrolysis) of fats, the concentration of toxic products of thermal oxidation increases sharply.

Products prepared according to the proposed invention have biologically valuable substances and organoleptic characteristics: they are characterized by high taste qualities, such as juiciness, softness, low caloric content. Also, the spherical shape of the products allows you to get the product with a uniform golden and crispy crust, which increases the attractive appearance for the product and allows you to increase the shelf life of the finished product while maintaining the softness of the test part of the product.

Thus, the task is solved, the goal is achieved, the result of the implementation of the claimed method of manufacture is a product enriched with proteins, minerals: iron, magnesium, potassium, calcium, sodium, phosphorus, fat-soluble vitamins (A, E and D), group B vitamins, ascorbic acid, taking into account ensuring stable organoleptic properties in all stages of preparation, including the process of frying products in deep-frying, in which fat components for frying in deep-fried citric acid are added prevention of oxidative processes, that allows you to get a product with a uniform golden crust.

This allows us to consider the finished product a functional purpose, prepared under the optimum technological characteristics: the production time, the simplicity of the technological operations, availability of the raw materials used, the affordability of raw materials.

### THE IMPLEMENTATION OF THE INVENTION

The method is carried out as follows:

Preparation of yeast dough is carried out in the sourdough way, all raw materials are kneaded at once. In water heated to 35° C., sugar, yeast, salt are diluted, all mixed until dissolved, add wheat flour of the highest grade, knead the dough until it falls behind the walls of the bowl, made using such leaven for 20 minutes. The consistency of the yeast dough should be medium or thick consistency, which is determined by the ratio of flour and water given in the table.1.

TABLE 1

| | |
|---|---|
| Consistence of the test | Ratio of components of the test |

| | | |
|---|---|---|
| middle | flour:water | 1:0.4-0.5 |
| dense | flour:water | 2.5-3:1 |

Under the influence of flour enzymes and a complex of enzymes of yeast and sugar, sugar added during mixing is broken down to form simple sugars: glucose and fructose, which are then fermented to form ethyl alcohol and carbon dioxide, which makes it possible to obtain a dough with a porous structure when frying with the following composition, by weight., %:

| | |
|---|---|
| wheat flour of the premium | of 50% |
| yeast baking | of 10% |
| sugar | of 8% |
| salt | of 2% |
| water | of 30% |

The received dough is handled into small pieces weighing 20-40 grams, roll out the workpiece on the surface, greased with vegetable oil in the form of small flat cakes.

The mixture for the stuffing and the process of preparing the stuffing for the products is carried out in two stages. Preliminary processing of an offal and requirements for the quality of processed an offal are described in the book: L. M. Rein, E. V. Gritsay Technology of an offal of endocrine-farm and special raw materials, Ed. Moscow «Light and food industry», 1982.

At the first stage an offal of farm animals (beef, pork, mutton), with the following composition, by weight., %: lungs 30%, liver 30%, kidneys 10%, heart 30%, boil in water for 2 hours, at the same time spices are added to water, at the rate on 1 liter of water: pepper peas 5 grams, crumbled onions 40 grams, garlic 5 grams. The boiled components of a stuffing are passed through the meat grinder.

At the second stage, the received forcemeat is slightly stewed with the addition of vegetable oil for 10-20 minutes, at the end of suppression add onions which are passed through a meat grinder in a ratio, by weight. %: 10%-20% by weight of the stuffing, add salt, pepper to taste. The received forcemeat is removed with a special grid for the purpose of removal of excessive vegetable oil.

On the rolled flat cakes in the middle, the stuffing is placed and form a product in the form of balls with a diameter of 3 to 6 cm, the finished products are fried in deep fat.

Deep frying is super fast: from a few seconds to a minute, a maximum of two. Products are simply immersed in hot fat and instantly cooked into it, covered with a delicate, beautiful and smooth equal golden crust.

So mostly fried dough products—puff pastry mince pies, doughnuts, twigletsires, food potatoes for side dishes, some vegetables that they scrunched the fish in batter and pastry, fruits in pastry (apples).

Finished products are lowered and removed with a special grid. When removing the finished product is dried from excess oil, and the spherical shape of the product gives the product a equally roasted crust.

As fat components in deep frying use animal fats of the highest grade, which add vegetable oils, increasing the amount of fat make the product more crumbly and tasty, which do not stale for a long time. Fat components are taken in the ratio of weight, %: 30% pork fat, 30% beef fat, 40% vegetable oil.

The mixture of fat components for frying is also added citric acid at the rate of 2-3 grams per 100-150 grams of fat, which helps to beat off the smell when using animal fat and establishing a crisp while maintaining the softness for pastry part of the product, which allows to increase a period of storage of a finished product without loss of tastes.

Deep-fried conveniently and quickly with a large production line, can be used in public fast food outlets.

The prepared products according to the described technological process are realized in a hot form in catering establishments, have a juicy fragrant filling, a shell from a soft yeast dough with a crispy crust and have an unusual taste, have a low caloric content.

When used as fat components for deep-frying a mixture of vegetable oils and melted butter in a proportion 3:1, a feature of finished products is enrichment by their pleasant, creamy taste. 1 point of formula of invention.

As the result of implementation of the invention the product is obtained, possessing such positive characteristics as the presence of valuable nutrients in the recipe of the stuffing and the method of preparation, organoleptic characteristics: juiciness, softness, low calorific value taking into account their preservation during all stages of preparation, including the prevention of oxidizing processes during frying in deep fat by adding citric acid. Preparation of the product is carried out with optimal technological characteristics: production time, simplicity of technological operations, accessibility of raw materials used, affordability of raw materials for stuffing.

The method of implementation of the invention is illustrated by the following examples:

Example 1. Prepare the yeast dough and stuffing according to the described method of implementation of the invention. The formation of the finished product is carried out on automatic continuous machines, with mechanical cutting the dough is fed simultaneously with the filling. In this case, the dough sleeve with filling passes through the sealing diaphragm, automatically pinching the sleeve in 2 places with simultaneous separation of the molded and sealed product. Finished products are obtained spherical shape. Mechanical production of products with filling can significantly increase productivity and improve the quality of processing of products, which contributes to the efficiency of productivity in public fast food outlets.

Example 2. Preparation of dough and stuffing and the formation of finished products, deep-frying for example 1, characterized in that the stuffing consists of offal of poultry: chicken, goose with the following composition, by weight. %: stomach 40%, liver 30%, heart 30%.

Example 3. Preparation of the dough and stuffing and the formation of finished products for deep-frying for example 1, characterized in that the composition of the fat components in deep-frying includes lamb fat of the highest grade, taking into account the addition of vegetable oil in the ratio of mass., %: 40% of the total weight of fat components.

The addition of lamb fat of the highest grade enriches the finished product with biologically valuable nutrients: saturated and unsaturated fatty acids such as stearic acid, palmitic, myristic, capric, oil, lauric; mineral compounds: sodium, magnesium, copper, zinc, selenium; vitamins A,B1,E; and lamb fat is enriched with natural lanolin.

Example 4. Preparation of dough and stuffing, the formation of finished products. The finished products are frozen at the food plant and placed in sealed food boxes of 6-10 pieces (in one box each product of the same weight) before delivery to the point of catering with a period of storage up to 24 hours.

Before deep-frying frozen products are subjected to defrosting (defrosting) in a slow way.

Cooking by deep-frying is carried out for example 1.

The presence of biologically valuable nutrients offal of farm animals is presented in the book: the Chemical composition of Russian food Ed. Delhi print, Moscow, 2002; in the book: L. M. rein, E. V. Gritsay Technology of an offal of endocrine-enzyme and special raw materials, Ed. Moscow «Light and food industry», 1982

The invention makes it possible to obtain a functional product having a high nutritional value, organoleptic characteristics, satisfies the criterion of novelty, since in determining the level of technology no method is found that has inherent characters identical (that is, coinciding in the function performed by them and the form of performing these characters) to all the characters listed in the formula of the invention, including the characteristics of the purpose.

The method of preparation of dough products with stuffing involves an inventive step, since it is not identified technical solutions, having the characters coincide with the distinctive characters of the present invention, and is not installed fame of influence of distinctive characters on the specified technical result.

The claimed technical solution can be implemented in industrial food production, in public catering. This corresponds to the criterion of «industrial applicability» to the invention.

### SOURCES

1. Chemical composition of Russian food products Ed. Delhi print, Moscow, 2002

2. L. M. Rein, E. V. Gritsay Technology of by-products of endocrine-enzyme and special raw materials, Ed. Moscow «Light and food industry», 1982

3. Patent RU 2280365 C2, May 12, 2004.

4. Patent RU 2578343 C1, Jan. 20, 2015.

5. Patent RU 2251271 C1, Oct. 6, 2003.

6. Patent RU 2093988 C1, Mar. 17, 1997.

1. The method for manufacturing dough products with a stuffing, comprising:
kneading yeast fermented dough while producing a precipitation of wheat flour in warm water in which sugar, salt, and yeast are diluted;
holding the dough for 20 minutes while obtaining semi-fluid dough;
cutting the semi-fluid dough on the surface with greased vegetable oil in the form of small flat cakes weighing 20-40 grams;
making a stuffing that includes an offal of the farming animals or poultry that are boiled in water for 2 hours;
adding spices to water in a proportion of one liter of water to:
black pepper peas of 1 gram;
crumbled onions 15 grams;
garlic 5 grams;
boiling the stuffing and passing the stuffing through a meat grinder until the stuffing is minced;
slightly stewing the minced stuffing in vegetable oil for 10 min.-20 min, at the end of stewing the crumbled onions added thereto which are passed through a meat grinder in an amount of 10%-20% by weight of the stuffing;
mixing components of the stuffing with salt and pepper;
molding the finished products in the form of a ball with a diameter of 3 to 6 cm;
frying the products in the form of balls with the stuffing in a deep-fried at a temperature 170-190° C.;
at the same time, fat components for frying consist of the animal fat of the highest grade selected from pork fat, beef fat, mutton fat and vegetable oils in an amount of 40% of the total amount of fat components, or mixing vegetable oils and melted butter in a proportion of 3:1,
adding citric acid to fat components for frying at a rate of 2-3 grams per 100-150 grams of fat for preventing oxidative processes of fat changes in the frying process in deep fry and for hurling back of a smell when using animal fats and obtaining a crispy crust while maintaining the softness of the dough part of the products, allowing an increase a period of storage of the finished product without loss of tastes.

2. The method on claim 1, differing in that as offal of farm animals use beef, pork and lamb lungs, a liver, kidneys, heart.

3. The method on claim 1, differing in that as offal of poultry use chicken and goose stomachs, a liver, heart.
